(19) United States
(12) Patent Application Publication
(10) Pub. No.: US 2025/0235881 A1
(43) Pub. Date: Jul. 24, 2025

(54) SPRAYER HEAD

(71) Applicant: SHIN TAI SPURT WATER OF THE GARDEN TOOLS CO., LTD, Lukang Township (TW)

(72) Inventor: Chin-Yuan Chen, Lukang Township (TW)

(21) Appl. No.: 18/416,866

(22) Filed: Jan. 18, 2024

(51) Int. Cl. B05B 1/12; B05B 9/01; B05B 15/65

(52) U.S. Cl. CPC B05B 1/12; B05B 9/01; B05B 15/65

(57) ABSTRACT

A sprayer head has a main body and an output head, wherein the main body comprises an output column with a water channel having a plurality of output aperture channels passing through the output column; the output column comprises a first threaded section and a control lever at a closed front end, and the control lever is jacketed with a first sealing ring. The output head has a connecting ring, a conic sleeve and a control member, the connecting ring being made of plastic and having a second threaded section for engaging with the first threaded section, and two opposing latches on an outer periphery; the conic sleeve is made of metal and has two opposing L-shaped rotatable slots on an outer periphery.

### BACKGROUND OF INVENTION

### Field of Invention

The present invention relates to a sprayer head

### Description of Related Art

Current common gardening water spray guns, most of them are as shown in FIG. 8, include: a main body 30 and an output head 40. The main body 30 is provided with an output column 31 having a water channel 311 inside, and at a front end of the water channel 311, there are a plurality of output apertures 312 passing the output column 31 laterally. The outer circumference of the output column 31 is provided with the first threaded section 313, the front closed end of the output column 31 has a control lever 314 extending out with a reduced diameter, and a first sealing ring 32 is placed on the control lever 314. The inner wall of the output head 40 is provided with the second threaded section 401 with a second sealing ring 41 and an output opening 402 at the front end, and the outer periphery of the output head 40 is combined with a control member 42. When the output head 40 uses the second threaded section 401 to engage with the first threaded section 313 of the main body 30, the control lever 314 is placed in the output opening 402, so that the control member 42 can be used to drive the output head 40 to rotate forward and reverse on the main body 30 to change the gap size between the output opening 402 and the control lever 314, to control the opening and closing of water, or change the shape of the water output as shown in FIG. 9.

However, the above conventional structure still has the following problems in practical applications: the entire output head 40 is made of metal copper ingots. Therefore, the overall weight is relatively heavy and it is relatively impossible to achieve lightweight. Requester: also after the output head 40 is made, the second threaded section 401 needs to be threaded on the inner wall of the output head 40, so the overall production process is long and the processing cost is high.

Therefore, it is desirable to provide a sprayer head to mitigate and/or obviate the aforementioned problems.

### SUMMARY OF INVENTION

An objective of present invention is to provide a sprayer head, which is capable of improving the above-mention problems.

In order to achieve the above mentioned objective, a sprayer head has a main body and an output head, wherein the main body comprises an output column with a water channel having a plurality of output aperture channels passing through the output column; the output column comprises a first threaded section and a control lever at a closed front end, and the control lever is jacketed with a first sealing ring. The output head has a connecting ring, a conic sleeve and a control member, the connecting ring being made of plastic and having a second threaded section for engaging with the first threaded section, and two opposing latches on an outer periphery; the conic sleeve is made of metal and has two opposing L-shaped rotatable slots on an outer periphery.

Other objects, advantages, and novel features of invention will become more apparent from the following detailed description when taken in conjunction with the accompanying drawings.

### BRIEF DESCRIPTION OF DRAWINGS

FIG. 1 is a three-dimensional combination of a preferred embodiment according to the present invention.

FIG. 2 is a three-dimensional exploded view of the preferred embodiment according to the present invention.

FIG. 3 This is a drawing of the connecting ring and the conic sleeve of the preferred embodiment according to the present invention.

FIG. 4 is a combined cross-sectional view of the preferred embodiment according to the present invention.

FIG. 5 is a partial enlarged view of the cross-section of the preferred embodiment according to the present invention.

FIG. 6 is an enlarged view of the combined cross-section from another angle of the preferred embodiment according to the present invention.

FIG. 7 is a state diagram of adjusting the shape of the water splash in the preferred embodiment according to the present invention.

FIG. 8 is a water outlet state diagram of a conventional structure.

FIG. 9 is a state diagram of water in a diffuse shape after adjustment according to the conventional structure.

### DETAILED DESCRIPTION OF PREFERRED EMBODIMENT

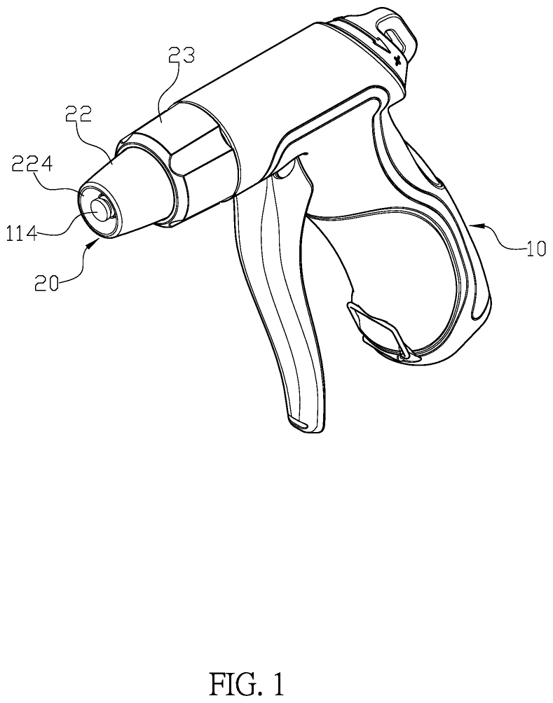

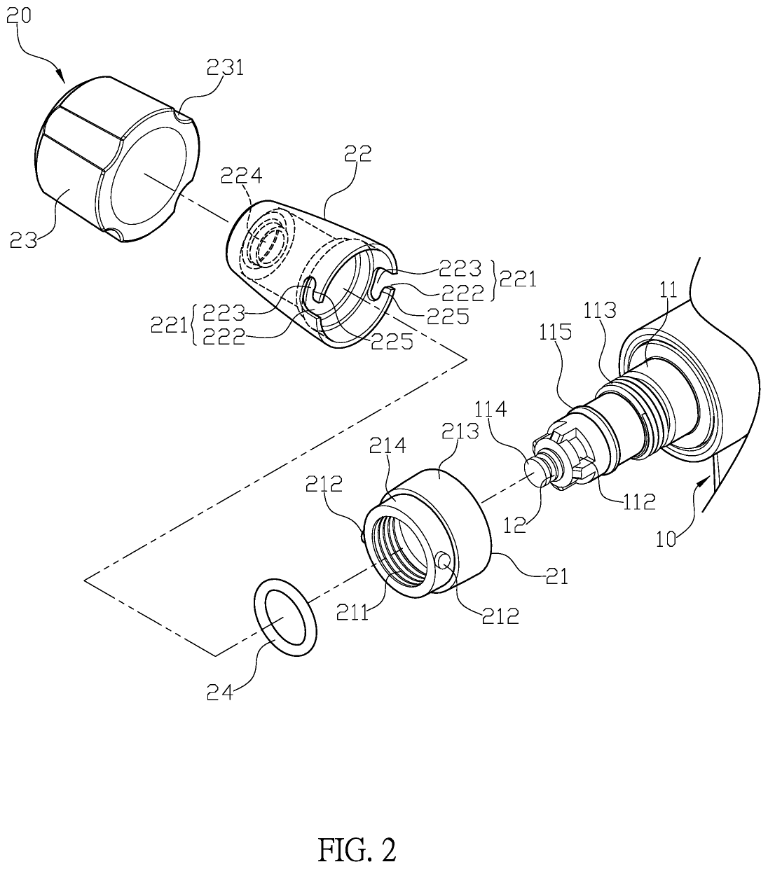

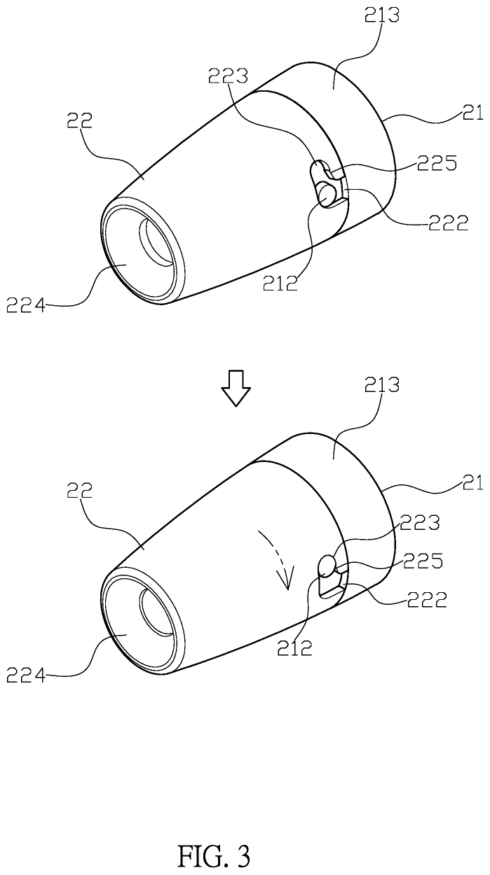

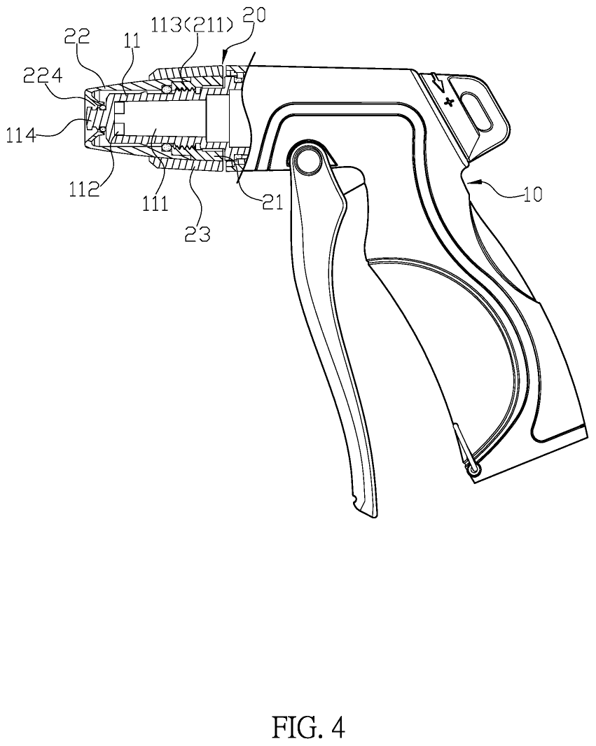

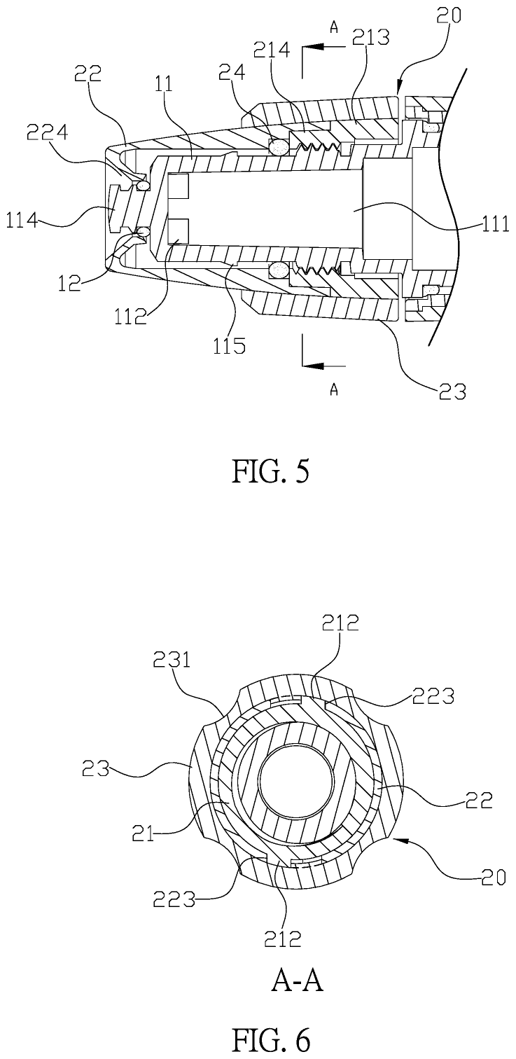

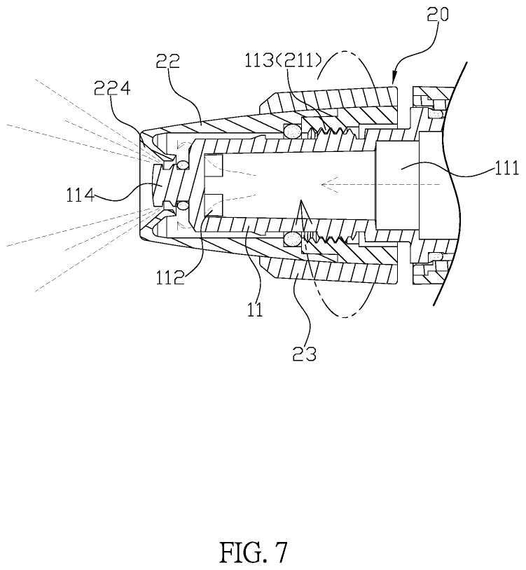

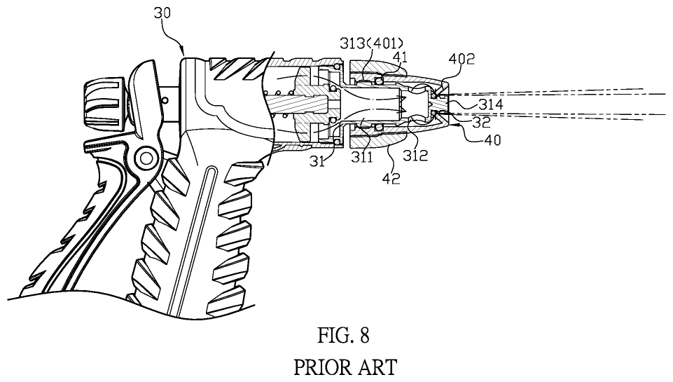

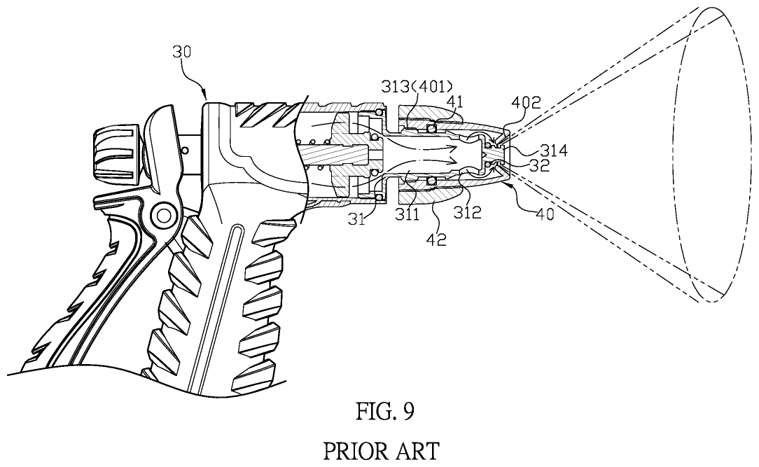

First, please refer to FIGS. 1 to 6. A sprayer head comprises a main body 10 and an output head 20. The main body 10 comprises an output column 11 with a water channel 111 having a plurality of output aperture 112 passing through the output column 11. The output column 11 comprises a first threaded section 113 and a control lever 114 at a closed front end, and the control lever 114 is jacketed with a first sealing ring 12. The output head 20 comprises a connecting ring 21, a conic sleeve 22 and a control member 23. The connecting ring 21 is made of plastic and having a second threaded section 211 at an inner wall for engaging with the first threaded section 113 and two opposing latches 212 on an outer periphery. The conic sleeve 22 is made of metal and has two opposing L-shaped rotatable slots 221 on an outer periphery. The rotatable slot 221 an opening section 222 for accepting one of the latches and an engaging section 223 for engaging with the latch 212, to quickly combine the connecting ring 21 and the conic sleeve 22. After the connecting ring 21 are the conic sleeve 22 are combined, the control member 23 covers the connecting ring 21 and the conic sleeve 22, and the second threaded section 211 of the connecting ring 21 engages with the first threaded section 113 of the main body 10 such that the control lever 114 is placed in an output opening 224 of the conic sleeve 22. The conic sleeve 22 and the connecting ring 21 completely surround the output column 11. Through the control member 23, the connecting ring 21 and the conic sleeve 22 are driven to rotate forward and backward on the main body 10 to change the gap size between the output opening 224 and the control lever 114, which controls the opening and closing of the water output, or to change the shape of the water output, please also refer to FIG. 7. Furthermore, there is a second sealing ring 24 sandwiched between the connecting ring 21 and the conic sleeve 22.

Moreover, the output column 11 further has a stopping edge 115 at an outer periphery for limiting the movement of the output head 20.

In addition, the connecting ring 21 further has a first main body portion 213 with a larger diameter and a second main body portion 214 with a smaller diameter, such that the second threaded section 211 and the latch 212 are both capable of being disposed on the second main body portion 214.

Also, the output opening 224 of the conic sleeve 22 is designed to be in the shape of an inverted cone with the aperture increasing from small to large.

Furthermore, the engaging section 223 further has a limiting edge 225 adjacent to the opening section 222 of the rotatable slot 221, for positioning the latch 212.

Additionally, the control member 23 member is formed by a plastic injection coating process on the connecting ring 21 and the conic sleeve 22.

Moreover, the control member 23 further has an anti-slip portion at an outer periphery 231.

Also, the anti-slip portion 231 is a groove or a protruding rib.

With the structure of the above specific embodiment, the following benefits can be obtained: first, partial of the output head 20 is replaced by the connecting ring 21 made of plastic, which reduces the proportion of the conic sleeve, so the overall weight of the output head 20 can be lighter; secondly, the rotatable slot 221 is configured for allowing the latch 212 to be rotated and engaged, which can achieve rapid assembly between the connecting ring 21 and the conic sleeve 22; thirdly, the metal conic sleeve 22 has an anti-break characteristic, allowing the output head 20 to have high strength while lightweight; and fourth, the second threaded section 211 is located on the plastic connecting ring 21, the conic sleeve 22 does not need to be threaded separately, which effectively reduce the processing difficulty and production cost of the output head 20.

Although the present invention has been explained in relation to its preferred embodiment, it is to be understood that many other possible modifications and variations can be made without departing from the spirit and scope of invention as hereinafter claimed.

What is claimed is:

1. A sprayer head comprising a main body and an output head, wherein the main body comprises an output column with a water channel having a plurality of output aperture channels passing through the output column; the output column comprises a first threaded section and a control lever at a closed front end, and the control lever is jacketed with a first sealing ring; characterized in that:
the output head comprises a connecting ring, a conic sleeve and a control member, the connecting ring being made of plastic and having a second threaded section for engaging with the first threaded section, and two opposing latches on an outer periphery; the conic sleeve is made of metal and has two opposing L-shaped rotatable slots on an outer periphery; the rotatable slot has an opening section for accepting one of the latches and an engaging section for engaging with the latch; the control member is capable of covering the connecting ring and the conic sleeve, the second threaded section of the connecting ring engaging with the first threaded section of the main body such that the control lever is capable of being placed in an output opening of the conic sleeve, the conic sleeve and the connecting ring completely surrounding the output column, and a second sealing ring is sandwiched between the connecting ring and the conic sleeve.

2. The sprayer head as claimed in claim 1, wherein the output column further has a stopping edge at an outer periphery.

3. The sprayer head as claimed in claim 1, wherein the connecting ring further has a first main body portion with a larger diameter and a second main body portion with a smaller diameter, such that the second threaded section and the latch are both capable of being disposed on the second main body portion.

4. The sprayer head as claimed in claim 1, wherein the engaging section further has a limiting edge adjacent to the opening section of the rotatable slot.

5. The sprayer head as claimed in claim 1, wherein the control member is formed by a plastic injection coating process on the connecting ring and the conic sleeve.

6. The sprayer head as claimed in claim 1, wherein the control member further has an anti-slip portion at an outer periphery.
